(19) United States
(12) Patent Application Publication
(10) Pub. No.: US 2007/0070992 A1
(43) Pub. Date: Mar. 29, 2007

(54) System and method for providing voice over internet protocol service using cellular phone

(76) Inventors: Jin-Suk Lee, Suwon-si (KR); Myeon-Kee Youn, Namdong-gu (KR)

Correspondence Address: Robert E. Bushnell, Suite 300, 1522 K Street, N.W., Washington, DC, 20005, US

(21) Appl. No.: 11/476,809

(22) Filed: Jun. 29, 2006

(30) Foreign Application Priority Data
Jul. 22, 2005 (KR) 10-2005-0066948

(51) Int. Cl. H04L 12/66

(52) U.S. Cl. 370/356

(57) ABSTRACT

In a system and method of providing Voice over Internet Protocol (VoIP) service, when a wireless terminal and a VoIP service terminal are connected on a VoIP service dedicated line, and the wireless terminal transmits to the VoIP service terminal a message requesting call connection to a destination Internet Protocol (IP) terminal, the VoIP service terminal connects the call to the destination IP terminal according to the call connection request message, and transceives a voice packet according to different codec information between the wireless terminal and the VoIP service terminal.

### CLAIM OF PRIORITY

This application makes reference to, incorporates the same herein, and claims all benefits accruing under 35 U.S.C. §119 from an application for SYSTEM AND METHOD FOR PROVIDING VOICE OVER INTERNET PROTOCOL SERVICE USING CELLULAR PHONE earlier filed in the Korean Intellectual Property Office on 22 Jul. 2005 and there duly assigned Serial No. 10-2005-0066948.

### BACKGROUND OF THE INVENTION

1. Technical Field

The present invention relates to a system and method for providing voice over internet protocol service using a cellular phone.

2. Related Art

Voice over Internet Protocol (VoIP) is a method used to transmit voice information using the Internet protocol (IP). In general, this means sending voice information in digital form in discrete packets rather than in typical circuit-committed protocols of an existing public switched telephone network (PSTN). VoIP and Internet telephony allow telephone services to be realized by use of an existing IP network with no change, and thereby telephone users can make use of long-distance and international telephone services on the Internet and in an intranet environment at a local call charge.

However, to communicate with a VoIP terminal using a VoIP function at a cellular phone which performs voice communication through the existing Code Division Multiple Access (CDMA) network, a separate accessing device, such as wireless local area network (WLAN) or Bluetooth, must be built into the cellular phone for direct connection to the IP network.

The cellular phone connector and the wireless local area network (LAN) or Bluetooth are built into the existing cellular phone in a dual mode. Thus, in order to communicate with the VoIP terminal using the IP network, the mode must be converted.

In this manner, in order to communicate with the VoIP terminal using the IP network in a cellular phone which performs voice communication through the CDMA network, a separate hardware connecting module must be installed in the mobile phone. In addition, a vocoder for a corresponding codec must be separately installed in the cellular phone.

Therefore, since a separate module must be provided in the cellular phone during production of the cellular phone, a cellular phone which is capable of using the VoIP is restricted, and its production cost imposes a burden on manufacturers.

### SUMMARY OF THE INVENTION

It is, therefore, an objective of the present invention to provide a system and method for providing Voice over Internet Protocol (VoIP) service using a cellular phone, which system and method are capable of connecting a general cellular phone and an IP network connectable personal computer (PC) with a Universal Serial Bus (USB) cable so as to allow the general cellular phone to use Session Initiation Protocol (SIP)-based VoIP service through the PC.

According to an aspect of the present invention, a system for providing VoIP service comprises: a user terminal for requesting call connection to an arbitrary destination Internet Protocol (IP) terminal; and a relay terminal connected to the user terminal by a VoIP service dedicated line for connecting a call to the destination IP terminal when a VoIP call connection request message is transmitted from the user terminal, and for converting and transceiving a voice packet according to codec information of each of the user terminal and the destination IP terminal.

Preferably, the user terminal comprises: a first interface for transceiving the voice packet through a mobile communication network; a second interface connected to a relay terminal by a USB cable so as to transceive an IP voice packet; a user information database for storing user information for requesting the call connection to the destination IP terminal; a dialer for inputting a telephone number of the destination IP terminal; and a controller which, when transmitting the user information stored in the user information database to the relay terminal and receiving a user authentication message from the relay terminal, transmits the telephone number of the destination IP terminal inputted from the dialer to the relay terminal through the second interface.

Furthermore, the user information preferably includes at least one of an identification (ID) and a password of the user.

In addition, the user information database further includes at least one of information on individual telephone number address books inputted by the user and information on transmission/reception log lists.

Preferably, the relay terminal comprises: a first interface connected to the user terminal by a USB cable so as to transceive the voice packet; a gateway connected to an IP network to transceive the IP voice packet; a signaler for generating a signaling signal for the call connection with the destination IP terminal according to the call connection request of the user terminal; and a call controller which, when receiving the signaling signal generated by the signaler, connects the call to the destination IP terminal through the gateway, and converts and transceives the voice packet according to the codec information of each of the user terminal and the destination IP terminal.

Furthermore, the relay terminal further includes a Real-time Transport Protocol (RTP) manager for managing an RTP which transmits the voice packet, and a Real-time Transport Control Protocol (RTCP) which controls the RTP when the call is connected by the call controller.

The call controller preferably interconverts Qualcomm Code Excited Linear Prediction (QCELP) codec information of the voice packet transmitted by the user terminal and VoIP codec information of the voice packet transmitted by the destination IP terminal so as to transmit the voice packet.

According to another aspect of the present invention, a system for providing VoIP service comprises: a user terminal which, when transmitting user information to an IP network connectable relay terminal so as to receive an authentication message, performs conversion into a VoIP mode so as to request the relay terminal to connect a call to an arbitrary destination IP terminal.

Furthermore, the user terminal preferably comprises: a first interface for transceiving the voice packet through a mobile communication network; a second interface connected to the relay terminal by a USB cable so as to transceive an IP voice packet; a user information database for storing user information requesting the call connection to the destination IP terminal; a dialer for inputting a telephone number of the destination IP terminal; and a controller which, when transmitting the user information stored in the user information database to the relay terminal and receiving a user authentication message from the relay terminal, transmits the telephone number of the destination IP terminal inputted by the dialer to the relay terminal through the second interface.

According to yet another aspect of the present invention, a system for providing VoIP service comprises: a relay terminal which, when a request for call connection to an arbitrary destination IP terminal is generated by a user terminal in a VoIP mode state after authenticating user information transmitted by the user terminal, connects the requested call, and converts and transceives a voice packet according to codec information of each of the user terminal and the destination IP terminal.

Preferably, the relay terminal comprises: a first interface connected to the user terminal by a USB cable so as to transceive the voice packet; a gateway connected to an IP network to transceive the IP voice packet; a signaler for generating a signaling signal for the call connection with the destination IP terminal according to a call connection request of the user terminal; and a call controller which, when receiving the signaling signal generated by the signaler, connects the call to the destination IP terminal through the gateway, and converts and transceives the voice packet according to the codec information of each of the user terminal and the destination IP terminal.

According to yet another aspect of the present invention, a method for providing VoIP service using a user terminal comprises the steps of: connecting the user terminal and a relay terminal on a VoIP service dedicated line; transmitting, at the user terminal to the relay terminal, a message requesting call connection to an arbitrary destination IP terminal; and connecting, at the relay terminal, the call to the destination IP terminal according to the received call connection request message, and converting and transceiving a voice packet according to codec information of each of the user terminal and the destination IP terminal.

Preferably, the step of transmitting the call connection request message comprises the steps of: transmitting, at the user terminal to the relay terminal, user information so as to receive a user authentication message; and transmitting, at the user terminal to the relay terminal, a telephone number of the destination IP terminal.

According to yet another aspect of the present invention, a method for providing VoIP service using a user terminal comprises the steps of: transmitting user information to an IP network connectable relay terminal; and, when receiving a user authentication message from the relay terminal, performing conversion into a VoIP mode so as to request call connection to an arbitrary destination IP terminal.

According to yet another aspect of the present invention, a method for providing VoIP service using a user terminal comprises the steps of: authenticating user information transmitted by a user terminal; when a request for call connection to an arbitrary destination IP terminal is generated by the user terminal, connecting the requested call; and, when the requested call is connected, converting and transceiving a voice packet according to codec information of each of the user terminal and the destination IP terminal.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 shows the configuration of a system for providing Voice over Internet Protocol (VoIP) service using a cellular phone according to the present invention;

FIG. 2 shows the configuration of the cellular phone of FIG. 1;

FIG. 3 shows the configuration of a PC of FIG. 1; and

FIG. 4 shows a process of providing VoIP service using a cellular phone according to the present invention.

### DETAILED DESCRIPTION OF THE INVENTION

Hereinafter, the present invention will be described in more detail with reference to the accompanying drawings, in which exemplary embodiments of the invention are shown. In the drawings, like reference numbers and symbols refer to like elements throughout the specification. To enable a clear understanding of the present invention, related technology which is well known to those of ordinary skill in the art will not be described in detail.

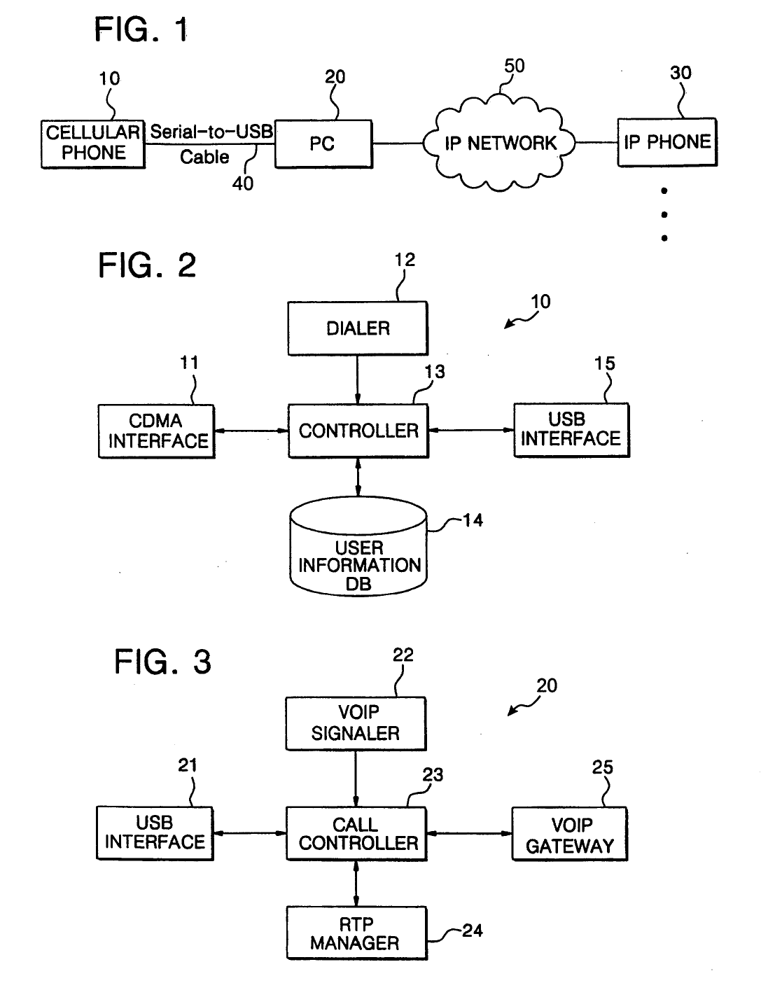

FIG. 1 shows the configuration of a system for providing Voice over Internet Protocol (VoIP) service using a cellular phone according to the present invention.

As shown in FIG. 1, the system for providing VoIP service generally comprises a cellular phone 10, a PC 20, and an IP phone 30.

The cellular phone 10 has a function of performing voice communication through a Code Division Multiple Access (CDMA) network. Particularly, when connected with the PC 20 through a serial-to-USB cable 40, the cellular phone 10 is connected to an IP network 50 through a VoIP gateway of the PC 20, thereby performing VoIP voice communication with the destination IP phone 30.

When the cellular phone 10 is connected through the serial-to-USB cable 40, the PC 20 recognizes the connected cellular phone 10. In this way, when recognizing the cellular phone 10, the PC 20 transmits a VoIP mode message to the cellular phone 10, and then receives from the cellular phone 10 a response message and user information which includes an ID and a password of the user.

In this manner, after the PC 20 authenticates the user information (i.e., the ID/password) received from the cellular phone 10, and when a request for call connection to the IP phone 30 connected to the IP network 50 is generated by the cellular phone 10, the PC 20 connects the requested call so as to allow voice communication to be performed between the cellular phone 10 and the IP phone 30, which is the destination terminal connected to the IP network 50.

FIG. 2 shows the configuration of the cellular phone of FIG. 1.

As shown in FIG. 2, the cellular phone 10 includes a CDMA interface 11, a dialer 12, a controller 13, a user information database (DB) 14, and a USB interface 15.

The CDMA interface 11 is an interface used when the cellular phone 10 performs voice communication with another cellular phone through a CDMA network when not connected to the PC 20 through the serial-to-USB cable 40.

The dialer 12 is used by a user for inputting a telephone number of a destination terminal for VoIP signaling in a state wherein the cellular phone 10 receives a VoIP mode preparation message. In this manner, the input telephone number of the destination terminal is delivered to the controller 13, and is transmitted to the PC 20 through the USB interface 15.

When the cellular phone 10 is connected to the PC 20 through the serial-to-USB cable 40, and when the controller 13 receives a VoIP mode message from the PC 20 through the USB interface 15, controller 13 transmits its response message and user information to the PC 20.

In this way, when the controller 13 receives the VoIP mode preparation message from the PC 20 by normal authentication of user information (i.e., ID/password) transmitted to the PC 20, the controller 13 performs VoIP signaling with an arbitrary destination terminal which is connected to the IP network 50.

That is, when receiving the VoIP mode preparation message, the controller 13 transmits the telephone number of the destination terminal inputted via the dialer 12 (that is, IP address information of the destination terminal) to the PC 20 connected through the serial-to-USB cable 40.

Thus, after connecting a call to the telephone number of the destination terminal transmitted by the cellular phone 10, the PC 20 transmits a call connect message reporting connection of the requested call to the cellular phone 10.

Thus, when voice communication is performed with the destination terminal, the controller 13 controls the voice communication to be normally performed by compressing or decompressing voice packet data transceived through a handset of the cellular phone 10.

The user information DB 14 stores the user information (ID/password) so as to enable VoIP service using a general cellular phone. This user information is transmitted to the PC 20 when the cellular phone 10 is connected to the PC 20 through the serial-to-USB cable 40, and the information is then used as user authentication data.

Furthermore, the user information DB 14 stores the user ID/password information, as well as information relating to an individual telephone number address book of the user and information relating to transmission/reception log lists.

The USB interface 15 is an interface used for connecting the cellular phone 10 and the PC 20 through the serial-to-USB cable 40. When the connection is normally performed through the serial-to-USB cable 40, the USB interface 15 transmits/receives a voice packet to/from the destination terminal based on the call connection request of the cellular phone 10.

FIG. 3 shows the configuration of the PC of FIG. 1.

As shown in FIG. 3, the PC 20 includes a USB interface 21, a VoIP signaler 22, a call controller 23, an RTP manager 24, and a VoIP gateway 25.

The USB interface 21 is an interface used for connecting the PC 20 and the cellular phone 10 through the serial-to-USB cable 40. The serial-to-USB cable 40 is recognized by installing a USB device driver in the PC 20.

When receiving a telephone number of an arbitrary destination terminal from the cellular phone 10 on the basis of the SIP signaling protocol, the VoIP signaler 22 transmits, to the call controller 23, a signaling signal for call connection to the corresponding destination terminal.

When receiving the signaling signal for call connection to the destination terminal from the VoIP signaler, the call controller 23 connects a call to an IP address corresponding to the telephone number of the destination terminal, and transmits a connect message reporting that the call is connected to the cellular phone 10 through the USB interface 21.

Furthermore, when the call is connected between the cellular phone 10 requesting the call connection and the destination IP terminal and thus a voice packet is transmitted/received, the call controller 23 converts the voice packet, which has been compressed by a QCELP codec and transmitted from the cellular phone 10, using a VoIP codec such as G.711 or G.723, and transmits the converted voice packet to the destination IP terminal. Controller 23 also converts the voice packet, which has been compressed by the VoIP codec such as G.711 or G.723 and transmitted from the destination IP terminal, using the QCELP codec, and transmits the converted voice packet to the cellular phone 10.

The RTP manager 24 controls the VoIP voice communication so that it is favorably performed by managing an RTP for transmitting IP voice packets and an RTCP for controlling the RTP.

The VoIP gateway 25 is a network interface for connecting to a Wibro/IP network so as to transmit/receive an IP voice packet. The VoIP gateway 25 transmits the voice packet transmitted by the cellular phone 10 to the destination terminal, and transmits the voice packet transmitted by the destination terminal to the cellular phone 10.

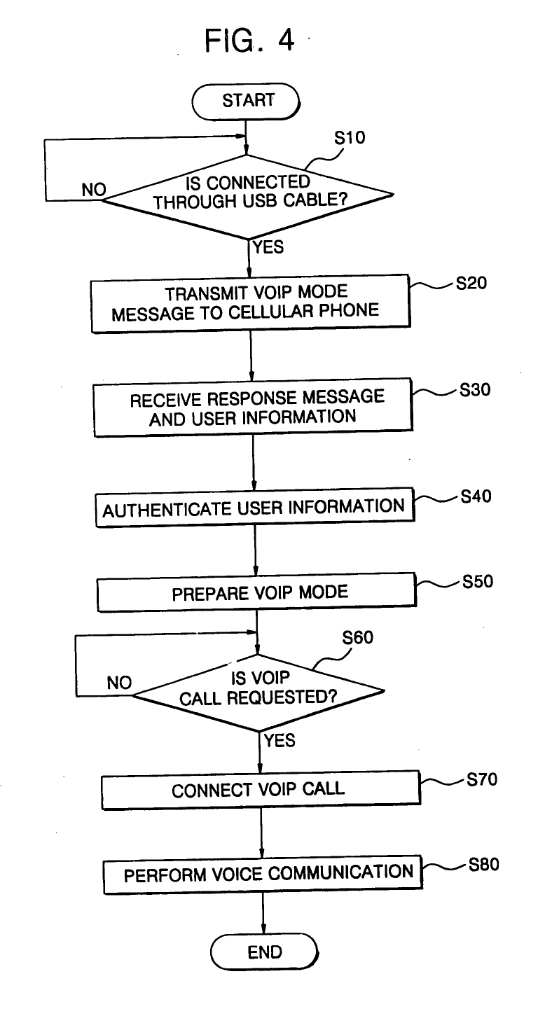

FIG. 4 shows a process of providing VoIP service using a cellular phone in accordance with the present invention.

As shown in FIG. 4, first, the PC 20 determines whether it is connected to the cellular phone 10 through the serial-to-USB cable 40 (S10).

Subsequently, if it is determined that the PC 20 is connected to the cellular phone 10 through the serial-to-USB cable 40, the PC 20 transmits a VoIP mode message to the cellular phone 10 (S20).

Then, the PC 20 receives, from the cellular phone 10, a response message for the transmission of the VoIP mode message and user information, including the ID/password of the user (S30).

Subsequently, the PC 20 authenticates the user ID/password information received from the cellular phone 10 (S40). When the authentication is normally executed, the PC 20 transmits the authenticated result to the cellular phone 10. Thereby, the cellular phone 10 sets up a VoIP mode capable of performing VoIP voice communication with an arbitrary destination terminal (S50).

Then, the PC 20 determines whether a request for VoIP call connection to the arbitrary destination IP terminal is generated by the cellular phone 10 (S60).

When it is determined that the request for VoIP call connection to the arbitrary destination IP terminal is generated by the cellular phone 10, the PC 20 connects the VoIP call to an IP address corresponding to a telephone number of the destination terminal on the basis of the SIP signaling protocol (S70).

Thus, after receiving a connect message from the PC 20, reporting that the call is connected, the cellular phone 10 performs VoIP voice communication with the destination terminal (S80).

In particular, when the call is connected, and thus voice communication is performed, the PC 20 converts the voice packet, which has been compressed by a QCELP codec and transmitted by the cellular phone 10, using a VoIP codec such as G.711 or G.723, and transmits the converted voice packet to the destination IP terminal. The PC 20 also converts the voice packet, which has been compressed by the VoIP codec, such as G.711 or G.723, and transmitted by the destination IP terminal, using the QCELP codec, and transmits the converted voice packet to the cellular phone 10.

According to the present invention, the general cellular phone and the IP network connectable PC are connected to each other by the USB cable. In this manner, the general cellular phone is enabled to use the SIP-based VoIP service through the PC, so that it is possible to more efficiently perform voice communication without a separate connection module for the VoIP service.

While the present invention has been described with reference to exemplary embodiments thereof, it will be understood by those skilled in the art that various changes in form and detail may be made therein without departing from the scope of the present invention as defined by the following claims.

What is claimed is:

1. A system for providing Voice over Internet Protocol (VoIP) service, comprising:
a user terminal for requesting call connection to an arbitrary destination Internet protocol (IP) terminal; and
a relay terminal connected to the user terminal by a VoIP service dedicated line for connecting a call to the destination IP terminal when a VoIP call connection request message is transmitted by the user terminal, and for converting and transceiving a voice packet according to codec information of each of the user terminal and the destination IP terminal.

2. The system of claim 1, wherein the user terminal comprises:
a first interface for transceiving the voice packet through a mobile communication network;
a second interface connected to the relay terminal by a Universal Serial Bus (USB) cable for transceiving an IP voice packet;
a user information database for storing user information for requesting the call connection to the destination IP terminal;
a dialer for inputting a telephone number of the destination IP terminal; and
a controller which, when transmitting the user information stored in the user information database to the relay terminal and receiving a user authentication message from the relay terminal, transmits the telephone number of the destination IP terminal, inputted via the dialer, to the relay terminal through the second interface.

3. The system of claim 2, wherein the user information includes at least one of an identification (ID) and a password of the user.

4. The system of claim 2, wherein the user information database further includes at least one of information relating to individual telephone number address books inputted by the user and information relating to transmission/reception log lists.

5. The system of claim 1, wherein the relay terminal comprises:
a first interface connected to the user terminal by a Universal Serial Bus (USB) cable for transceiving the voice packet;
a gateway connected to an IP network for transceiving an IP voice packet;
a signaler for generating a signaling signal for the call connection with the destination IP terminal according to a call connection request of the user terminal; and
a call controller which, when receiving the signaling signal generated by the signaler, connects the call to the destination IP terminal through the gateway, and converts and transceives the voice packet according to the codec information of each of the user terminal and the destination IP terminal.

6. The system of claim 5, wherein the relay terminal further comprises a Real-time Transport Protocol (RTP) manager for managing an RTP which transmits the voice packet, and for managing a Real-time Transport Control Protocol (RTCP) which controls the RTP when the call is connected by the call controller.

7. The system of claim 5, wherein the call controller interconverts Qualcomm Code Excited Linear Prediction (QCELP) codec information of the voice packet transmitted by the user terminal and VoIP codec information of the voice packet transmitted by the destination IP terminal so as to transmit the voice packet.

8. A system for providing Voice over Internet Protocol (VoIP) service, comprising:
a user terminal which, when transmitting user information to an Internet Protocol (IP) network connectable relay terminal so as to receive an authentication message, performs conversion into a VoIP mode so as to request the relay terminal to connect a call to a destination IP terminal.

9. The system of claim 8, wherein the user terminal comprises:
a first interface for transceiving a voice packet through a mobile communication network;
a second interface connected to the relay terminal by a Universal Serial Bus (USB) cable for transceiving an IP voice packet;
a user information database for storing user information for requesting call connection to the destination IP terminal;
a dialer for inputting a telephone number of the destination IP terminal; and
a controller which, when transmitting the user information stored in the user information database to the relay terminal and receiving a user authentication message from the relay terminal, transmits the telephone number of the destination IP terminal, inputted via the dialer, to the relay terminal through the second interface.

10. The system of claim 9, wherein the user information includes at least one of an identification (ID) and a password of the user.

11. The system of claim 9, wherein the user information database further includes at least one of information relating to individual telephone number address books inputted by the user and information relating to transmission/reception log lists.

12. A system for providing Voice over Internet Protocol (VoIP) service, comprising:
a relay terminal which, when a request for call connection to a destination Internet Protocol (IP) terminal is generated by a user terminal in a VoIP mode state after authenticating user information transmitted by the user terminal, connects the requested call, and converts and transceives a voice packet according to codec information of each of the user terminal and the destination IP terminal.

13. The system of claim 12, wherein the relay terminal comprises:
a first interface connected to the user terminal by a Universal Serial Bus (USB) cable for transceiving the voice packet;
a gateway connected to an IP network for transceiving an IP voice packet;
a signaler for generating a signaling signal for the call connection with the destination IP terminal according to a call connection request of the user terminal; and
a call controller which, when receiving the signaling signal generated by the signaler, connects the call to the destination IP terminal through the gateway, and converts and transceives the voice packet according to the codec information of each of the user terminal and the destination IP terminal.

14. The system of claim 13, wherein the relay terminal further comprises a Real-time Transport Protocol (RTP) manager for managing an RTP which transmits the voice packet, and for managing a Real-time Transport Control Protocol (RTCP) which controls the RTP when the call is connected by the call controller.

15. The system of claim 13, wherein the call controller interconverts Qualcomm Code Excited Linear Prediction (QCELP) codec information of the voice packet transmitted by the user terminal and VoIP codec information of the voice packet transmitted by the destination IP terminal so as to transmit the voice packet.

16. A method for providing Voice over Internet Protocol (VoIP) service at a user terminal through a relay terminal, the method comprising the steps of:
connecting the user terminal and the relay terminal by means of a VoIP service dedicated line;
transmitting, at the user terminal to the relay terminal, a message requesting call connection to a destination Internet Protocol (IP) terminal; and
connecting, at the relay terminal, the call to the destination IP terminal according to a received call connection request message, and converting and transceiving a voice packet according to codec information of each of the user terminal and the destination IP terminal.

17. The method of claim 16, wherein the step of transmitting the message requesting call connection comprises the steps of:
transmitting, at the user terminal to the relay terminal, user information so as to receive a user authentication message; and
transmitting, at the user terminal to the relay terminal, a telephone number of the destination IP terminal.

18. The method of claim 17, wherein the user information includes at least one of an identification (ID) and a password of the user.

19. The method of claim 16, wherein the transceiving of the voice packet comprises interconverting Qualcomm Code Excited Linear Prediction (QCELP) codec information of the voice packet transmitted by the user terminal and VoIP codec information of the voice packet transmitted by the destination IP terminal so as to transmit the voice packet.

20. A method for providing Voice over Internet Protocol (VoIP) service, the method comprising the steps of:
transmitting user information to an Internet Protocol (IP) network connectable relay terminal; and
when receiving a user authentication message from the relay terminal, performing conversion into a VoIP mode so as to request call connection to a destination IP terminal.

21. The method of claim 20, wherein the user information includes at least one of an identification (ID) and a password of the user.

22. A method for providing Voice over Internet Protocol (VoIP) service, the method comprising the steps of:
authenticating user information transmitted by a user terminal;
when a request for call connection to a destination Internet Protocol (IP) terminal is generated by the user terminal, connecting the requested call; and
when the requested call is connected, converting and transceiving a voice packet according to codec information of each of the user terminal and the destination IP terminal.

23. The method of claim 22, wherein the user information includes at least one of an identification (ID) and a password of the user.

24. The method of claim 22, wherein the transceiving of the voice packet comprises interconverting Qualcomm Code Excited Linear Prediction (QCELP) codec information of the voice packet transmitted by the user terminal and VoIP codec information of the voice packet transmitted by the destination IP terminal so as to transmit the voice packet.
